(19) United States
(12) Patent Application Publication
(10) Pub. No.: US 2025/0119182 A1
(43) Pub. Date: Apr. 10, 2025

(54) COORDINATION BETWEEN NETWORK DEVICES

(71) Applicant: QUALCOMM Incorporated, San Diego, CA (US)

(72) Inventors: Ahmed ELSHAFIE, San Diego, CA (US); Yu ZHANG, San Diego, CA (US); Hung Dinh LY, San Diego, CA (US); Huilin XU, Temecula, CA (US); Zhikun WU, Beijing (CN); Saeid SAHRAEI, San Diego, CA (US); Peter GAAL, San Diego, CA (US)

(21) Appl. No.: 18/865,810

(22) PCT Filed: Aug. 2, 2022
(86) PCT No.: PCT/CN2022/109642

§ 371 Date: Nov. 14, 2024

(51) Int. Cl. H04B 7/04; H04W 16/28

(52) U.S. Cl. CPC H04B 7/04026; H04W 16/28

(57) ABSTRACT

Various aspects of the present disclosure generally relate to wireless communication. In some aspects, a first network node may receive, from a second network node associated with a reconfigurable intelligent surface (RIS), positioning information associated with the RIS. The first network node may communicate, with a third network node, using a beam of a set of beams that is configured based at least in part on the positioning information. Numerous other aspects are described.

### FIELD OF THE DISCLOSURE

Aspects of the present disclosure generally relate to wireless communication and to techniques and apparatuses for coordination between network devices.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first network node. The method may include receiving, from a second network node associated with a reconfigurable intelligent surface (RIS), positioning information associated with the RIS. The method may include communicating, with a third network node, using a beam of a set of beams that is configured based at least in part on the positioning information.

Some aspects described herein relate to a method of wireless communication performed by a second network node. The method may include configuring an RIS associated with the second network node. The method may include transmitting, to a first network node and based at least in part on configuring the RIS, positioning information associated with the RIS to enable the first network node to communicate with a third network node using a beam of a set of beams that is configured based at least in part on the positioning information.

Some aspects described herein relate to a first network node for wireless communication. The first network node may include a memory and one or more processors coupled to the memory. The one or more processors may be configured to receive, from a second network node associated with an RIS, positioning information associated with the RIS. The one or more processors may be configured to communicate, with a third network node, using a beam of a set of beams that is configured based at least in part on the positioning information.

Some aspects described herein relate to a second network node for wireless communication. The second network node may include a memory and one or more processors coupled to the memory. The one or more processors may be configured to configure an RIS associated with the second network node. The one or more processors may be configured to transmit, to a first network node and based at least in part on configuring the RIS, positioning information associated with the RIS to enable the first network node to communicate with a third network node using a beam of a set of beams that is configured based at least in part on the positioning information.

Some aspects described herein relate to a non-transitory computer-readable medium that stores a set of instructions for wireless communication by a first network node. The set of instructions, when executed by one or more processors of the first network node, may cause the first network node to receive, from a second network node associated with an RIS, positioning information associated with the RIS. The set of instructions, when executed by one or more processors of the first network node, may cause the first network node to communicate, with a third network node, using a beam of a set of beams that is configured based at least in part on the positioning information.

Some aspects described herein relate to a non-transitory computer-readable medium that stores a set of instructions for wireless communication by a second network node. The set of instructions, when executed by one or more processors of the second network node, may cause the second network node to configure an RIS associated with the second network node. The set of instructions, when executed by one or more processors of the second network node, may cause the second network node to transmit, to a first network node and based at least in part on configuring the RIS, positioning information associated with the RIS to enable the first network node to communicate with a third network node using a beam of a set of beams that is configured based at least in part on the positioning information.

Some aspects described herein relate to a first apparatus for wireless communication. The first apparatus may include means for receiving, from a second apparatus associated with an RIS, positioning information associated with the RIS. The first apparatus may include means for communicating, with a third apparatus, using a beam of a set of beams that is configured based at least in part on the positioning information.

Some aspects described herein relate to a second apparatus for wireless communication. The second apparatus may include means for configuring an RIS associated with the second apparatus. The apparatus may include means for transmitting, to a first apparatus and based at least in part on configuring the RIS, positioning information associated with the RIS to enable the first apparatus to communicate with a third apparatus using a beam of a set of beams that is configured based at least in part on the positioning information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of communications using a reconfigurable intelligent surface (RIS), in accordance with the present disclosure.

FIG. 5 is a diagram illustrating an example of communication links in a wireless network that includes an RIS, in accordance with the present disclosure.

FIG. 6 is a diagram illustrating examples of beam management procedures, in accordance with the present disclosure.

FIG. 7 is a diagram illustrating an example of RIS configuration in a multi-operator scenario, in accordance with the present disclosure.

FIGS. 8A and 8B are diagrams illustrating an example associated with coordination between network devices, in accordance with the present disclosure.

FIG. 9 is a diagram illustrating an example process performed, for example, by a first network node, in accordance with the present disclosure.

FIG. 10 is a diagram illustrating an example process performed, for example, by a second network node, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

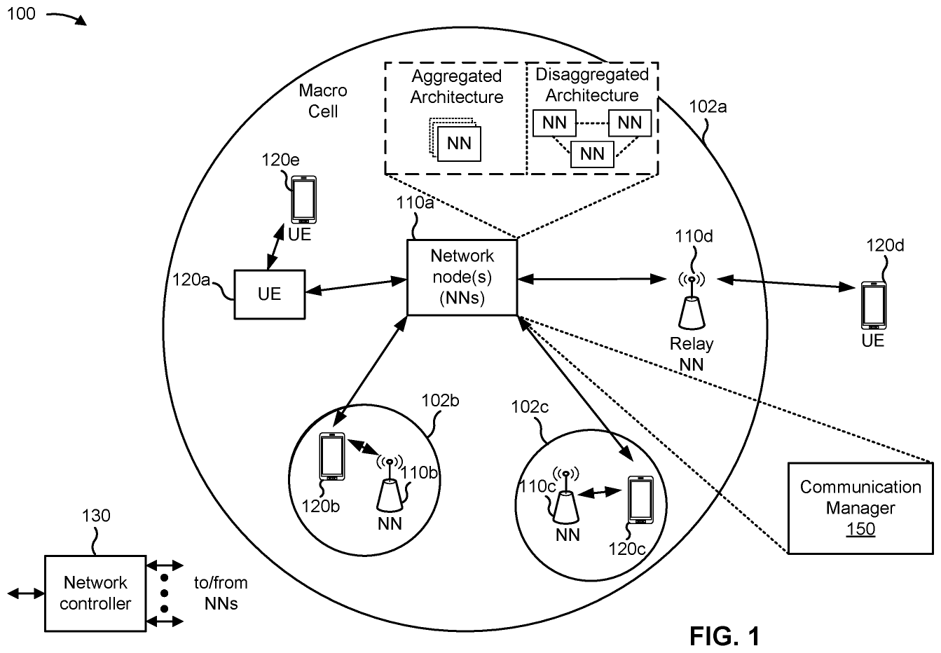

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first network node 110 may include a communication manager 150. As described in more detail elsewhere herein, the communication manager 150 may receive, from a second network node 110 associated with a reconfigurable intelligent surface (RIS), positioning information associated with the RIS; and communicate, with a third network node 110, using a beam of a set of beams that is configured based at least in part on the positioning information. Additionally, or alternatively, the communication manager 150 may perform one or more other operations described herein.

In some aspects, the second network node 110 may include a communication manager 150. As described in more detail elsewhere herein, the communication manager 150 may configure an RIS associated with the second network node; and transmit, to the first network node 110 and based at least in part on configuring the RIS, positioning information associated with the RIS to enable the first network node 110 to communicate with a third network node 110 using a beam of a set of beams that is configured based at least in part on the positioning information. Additionally, or alternatively, the communication manager 150 may perform one or more other operations described herein.

As indicated above, FIG. 1 is provided as an example. Other examples may differ from what is described with regard to FIG. 1.

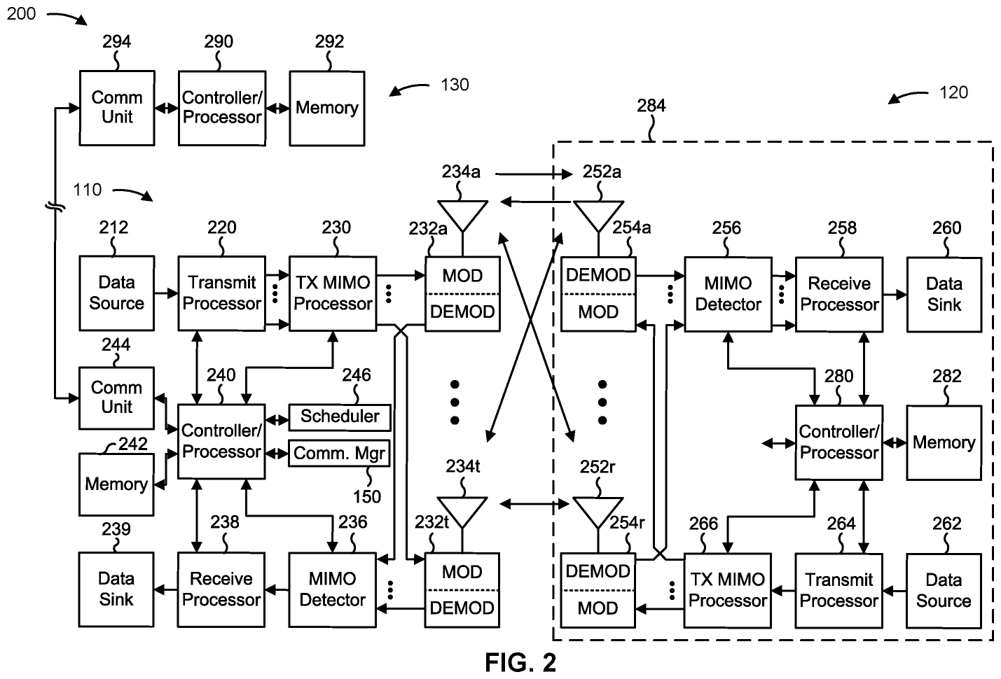

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

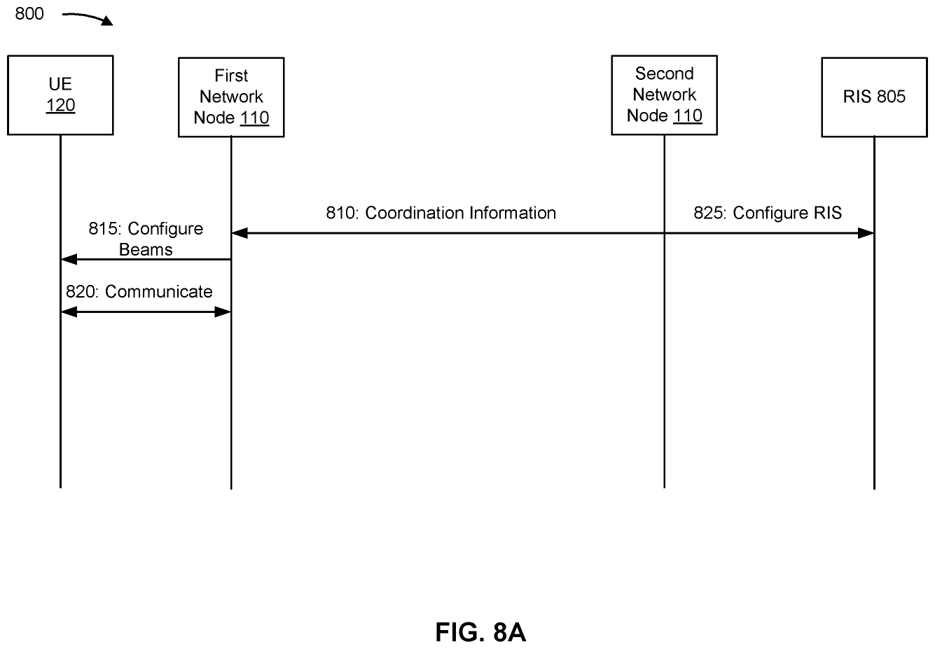

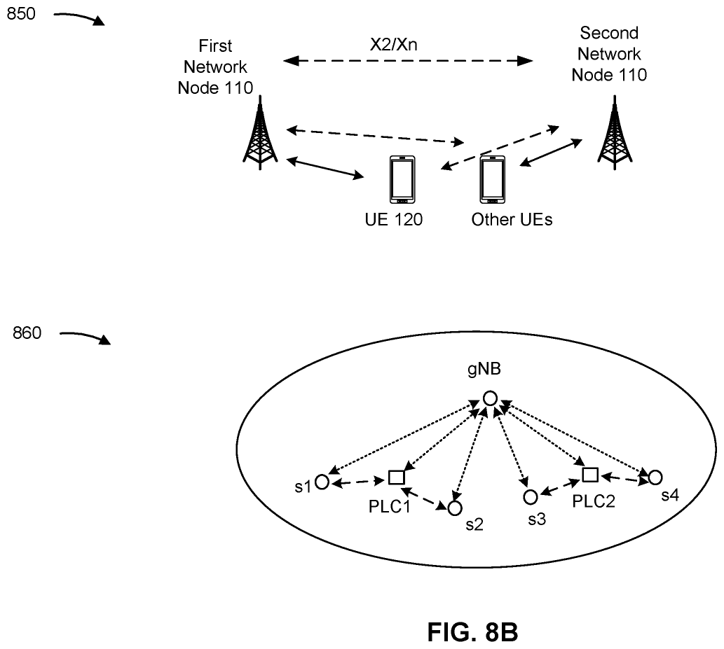

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8A-11).

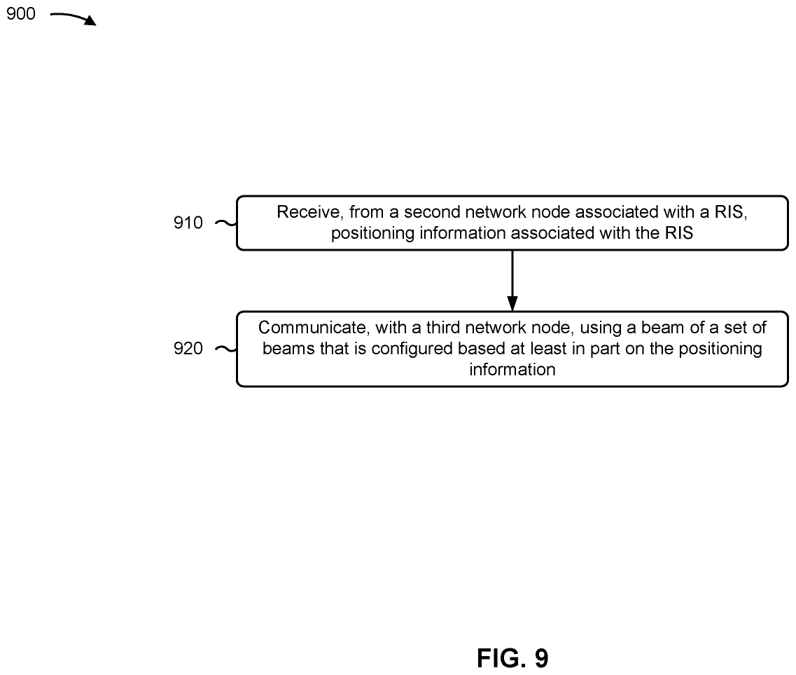

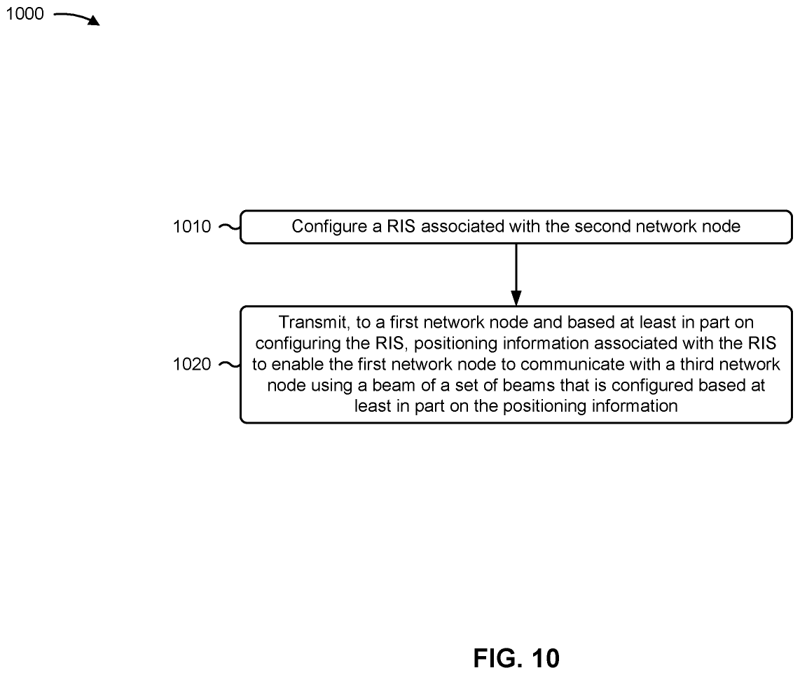

The controller/processor 240 of the network node 110, the controller/processor 280 of the UE 120, and/or any other component(s) of FIG. 2 may perform one or more techniques associated with coordination between network devices, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a first network node 110 includes means for receiving, from a second network node 110 associated with an RIS, positioning information associated with the RIS; and/or means for communicating, with a third network node 110, using a beam of a set of beams that is configured based at least in part on the positioning information. In some aspects, the means for the first network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the second network node 110 includes means for configuring an RIS associated with the second network node 110; and/or means for transmitting, to the first network node 110 and based at least in part on configuring the RIS, positioning information associated with the RIS to enable the first network node 110 to communicate with a third network node 110 using a beam of a set of beams that is configured based at least in part on the positioning information. In some aspects, the means for the second network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

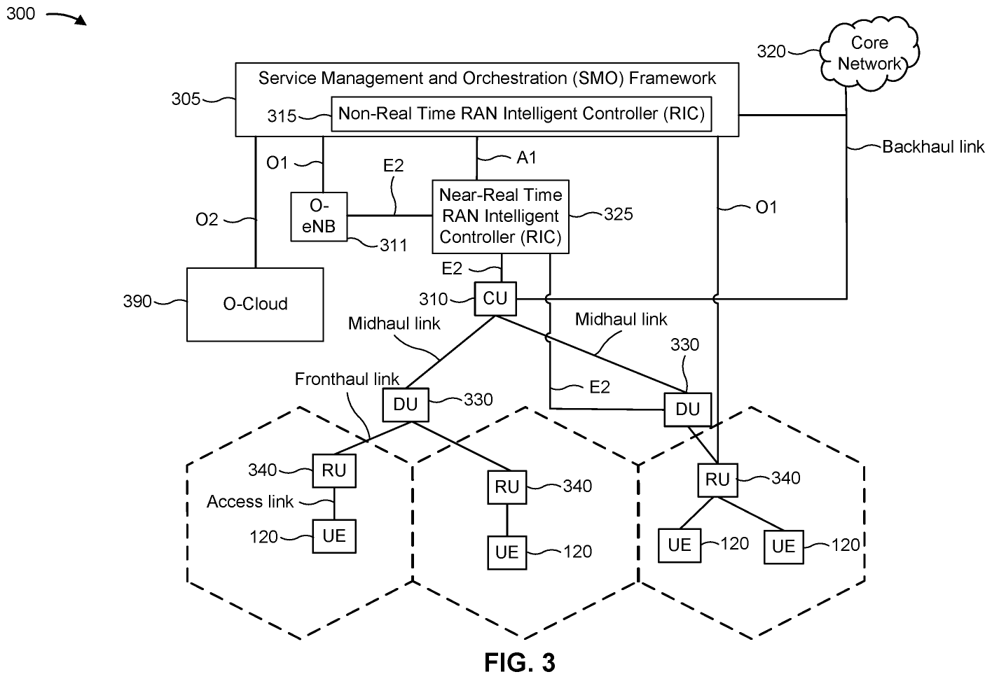

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

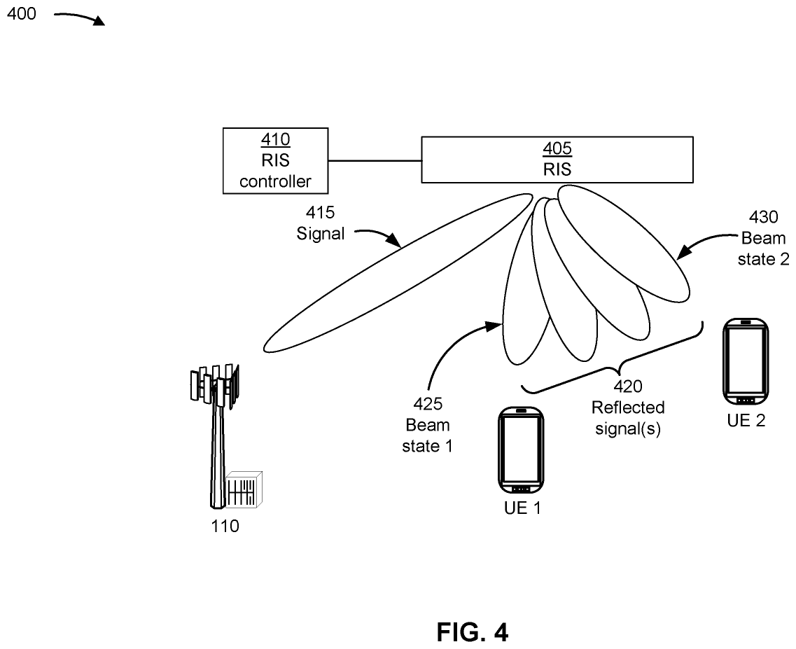

FIG. 4 is a diagram illustrating an example 400 of communications using a reconfigurable intelligent surface (RIS), in accordance with the present disclosure. As shown in FIG. 4, a network node 110 may communicate with a UE 120 in a wireless network, such as the wireless network 100. The network node 110 and the UE 120 may use an RIS 405 to communicate with one another. For example, the RIS 405 may reflect or redirect a signal to the network node 110 and/or the UE 120. The RIS 405 may also be referred to as an intelligent reflecting surface (IRS). In some examples, the RIS 405 may be a repeater.

The RIS 405 may be, or may include, a planar or two-dimensional structure or surface that is designed to have properties to enable a dynamic control of signals or electromagnetic waves reflected and/or redirected by the RIS 405. The RIS 405 may include one or more reconfigurable elements. For example, the RIS 405 may include an array of reconfigurable elements (e.g., an array of uniformly distributed reconfigurable elements). The reconfigurable elements may be elements with a reconfigurable electromagnetic characteristic. For example, the electromagnetic characteristic may include a reflection characteristic (e.g., a reflection coefficient), a scattering characteristic, an absorption characteristic, and/or a diffraction characteristic. The electromagnetic characteristic(s) of each reconfigurable element may be independently controlled and changed over time. The electromagnetic characteristic(s) of each reconfigurable element may be independently configured such that the combination of configured states of the reconfigurable elements reflects an incident signal or waveform in a controlled manner. For example, the reconfigurable elements may be configured to reflect or redirect an impinging signal in a controlled manner, such as by reflecting the impinging signal in a desired direction, with a desired beam width, with a desired phase, with a desired amplitude, and/or with a desired polarization, among other examples. In other words, the RIS 405 may be capable of modifying one or more properties (e.g., direction, beam width, phase, amplitude, and/or polarization) of an impinging signal.

The reconfigurable elements of the RIS 405 may be controlled and/or configured by an RIS controller 410. The RIS controller 410 may be a control module (e.g., a controller and/or a processor) that is capable of configuring the electromagnetic characteristic(s) of each reconfigurable element of the RIS 405. The RIS controller 410 may be, or may be included in, the communication manager 150 (e.g., of the network node 110). Alternatively, the communication manager 150 may be included in the RIS controller 410. The RIS controller 410 may receive control communications (e.g., from a network node 110 and/or a UE 120) indicating one or more properties of reflected signals (e.g., indicating a desired direction, a desired beam width, a desired phase, a desired amplitude, and/or a desired polarization). Therefore, in some examples, the RIS 405 may be capable of receiving communications (e.g., via the RIS 405 and/or the RIS controller 410).

As shown in FIG. 4, the network node 110 may transmit a signal 415. The signal 415 may be transmitted in a spatial direction toward the RIS 405. The RIS controller 410 may configure the reconfigurable elements of the RIS 405 to reflect and/or redirect the signal 415 in a desired spatial direction and/or with one or more desired signal characteristics (e.g., beam width, phase, amplitude, frequency, and/or polarization). For example, as shown by reference number 420, the RIS 405 may be capable of reflecting the signal 415 in one or more spatial directions. Although multiple beams are shown in FIG. 4 representing different beam states or beam directions of the RIS 405, the RIS 405 may be capable of reflecting a signal with one beam state or one beam direction at a time. For example, in one case, as shown by reference number 425, the RIS 405 may be configured to reflect the signal 415 using a first beam state (e.g., beam state 1). “Beam state” may refer to a spatial direction and/or a beam of a reflected signal (e.g., a signal reflected by the RIS 405). The first beam state may cause the signal 415 to be reflected in a spatial direction toward a first UE 120 (e.g., UE 1). As shown by reference number 430, in another case, the RIS 405 may be configured to reflect the signal 415 using a second beam state (e.g., beam state 2). The second beam state may cause the signal 415 to be reflected in a spatial direction toward a second UE 120 (e.g., UE 2).

The RIS 405 may be deployed in a wireless network (such as the wireless network 100) to improve communication performance and efficiency. For example, the RIS 405 may enable a transmitter (e.g., a network node 110 or a UE 120) to control the scattering, reflection, and refraction characteristics of signals transmitted by the transmitter, to overcome the negative effects of wireless propagation. For example, the RIS 405 may effectively control signal characteristics (e.g., spatial direction, beam width, phase, amplitude, frequency, and/or polarization) of an impinging signal without a need for complex decoding, encoding, and radio frequency processing operations. Therefore, the RIS 405 may provide increased channel diversity for propagation of signals in a wireless network. The increased channel diversity provides robustness to channel fading and/or blocking, such as when higher frequencies are used by the network node 110 and/or the UE 120 (e.g., millimeter wave frequencies and/or sub-terahertz frequencies). Moreover, as the RIS 405 does not need to perform complex decoding, encoding, and radio frequency processing operations, the RIS 405 may provide a more cost and energy efficient manner of reflecting and/or redirecting signals in a wireless network (e.g., as compared to other mechanisms for reflecting and/or redirecting signals, such as a relay device).

As indicated above, FIG. 4 is provided as an example. Other examples may differ from what is described with respect to FIG. 4.

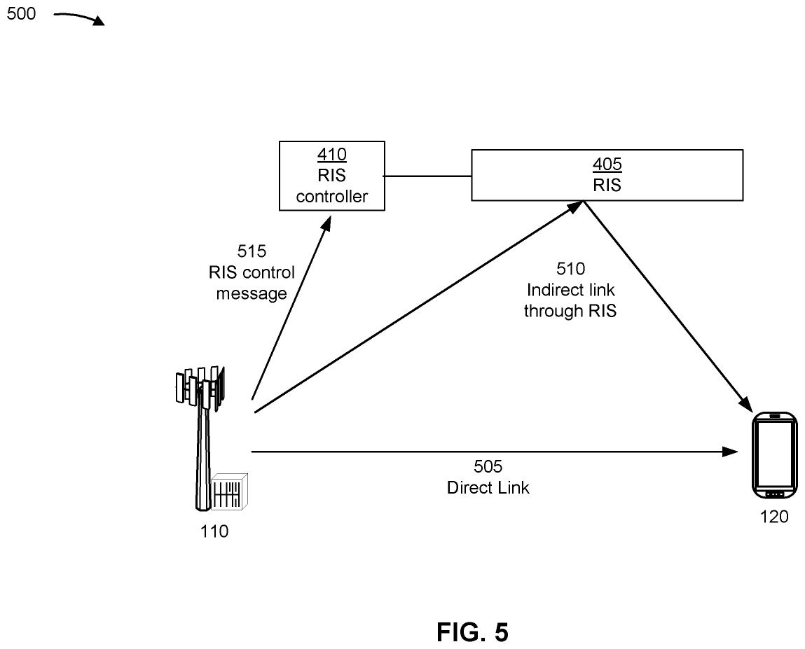

FIG. 5 is a diagram illustrating an example 500 of communication links in a wireless network that includes an RIS, in accordance with the present disclosure. As shown, example 500 includes a network node 110, a UE 120, and the RIS 405. The RIS 405 may be controlled and/or configured by the RIS controller 410.

As shown in FIG. 5, the UE 120 may receive a communication (e.g., data and/or control information) directly from the network node 110 as a downlink communication. Additionally, or alternatively, the UE 120 may receive a communication (e.g., data and/or control information) indirectly from the network node 110 via the RIS 405. For example, the network node 110 may transmit the communication in a spatial direction toward the RIS 405, and the RIS 405 may redirect or reflect the communication to the UE 120.

In some examples, the UE 120 may communicate directly with the network node 110 via a direct link 505. For example, a communication may be transmitted via the direct link 505. A communication transmitted via the direct link 505 between the UE 120 and the network node 110 does not pass through and is not reflected or redirected by the RIS 405. In some examples, the UE 120 may communicate indirectly with the network node 110 via an indirect link 510. For example, a communication may be transmitted via different segments of the indirect link 510. A communication transmitted via the indirect link 510 between the UE 120 and the network node 110 is reflected and/or redirected by the RIS 405. As shown in FIG. 5 and by reference number 515, the network node 110 may communicate with the RIS 405 (e.g., with the RIS controller 410) via a control channel. For example, the network node 110 may indicate, in an RIS control message, spatial direction(s) and/or signal characteristics for signals reflected by the RIS 405. The RIS controller 410 may configure reconfigurable elements of the RIS 405 in accordance with the RIS control message. Using the communication scheme shown in FIG. 5 may improve network performance and increase reliability by providing the UE 120 with link diversity for communicating with the network node 110.

In some cases, the UE 120 may receive a communication (e.g., the same communication) from the network node 110 via both the direct link 505 and the indirect link 510. In other cases, the network node 110 may select one of the links (e.g., either the direct link 505 or the indirect link 510), and may transmit a communication to the UE 120 using only the selected link. Alternatively, the network node 110 may receive an indication of one of the links (e.g., either the direct link 505 or the indirect link 510), and may transmit a communication to the UE 120 using only the indicated link. The indication may be transmitted by the UE 120 and/or the RIS 405. In some examples, such selection and/or indication may be based at least in part on channel conditions and/or link reliability.

As indicated above, FIG. 5 is provided as an example. Other examples may differ from what is described with respect to FIG. 5.

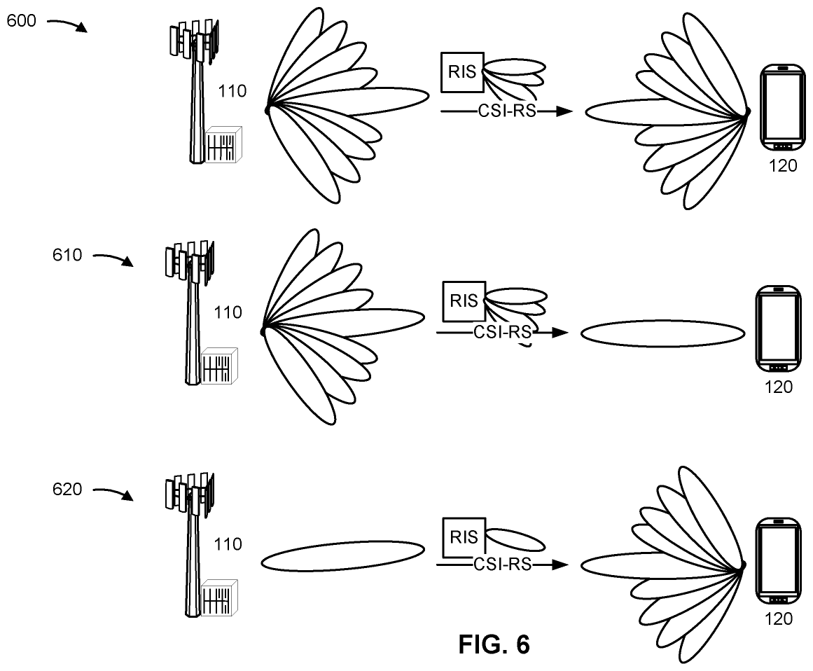

FIG. 6 is a diagram illustrating examples 600, 610, and 620 of beam management procedures, in accordance with the present disclosure. As shown in FIG. 6, examples 600, 610, and 620 include a UE 120 in communication with a network node 110 in a wireless network (e.g., wireless network 100). However, the devices shown in FIG. 6 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state). In some aspects, the UE 120 and the network node 110 may communicate using an RIS associated with an indirect link.

As shown in FIG. 6, example 600 may include a network node 110 (e.g., one or more network node devices such as an RU, a DU, and/or a CU, among other examples) and a UE 120 communicating to perform beam management using channel state information (CSI) reference signals (RSs) (CSI-RSs). Example 600 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 6 and example 600, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 600 has been described in connection with CSI-RSs, the first beam management process may also use synchronization signal blocks (SSBs) for beam management in a similar manner as described above.

In some aspects, at least one beam, transmitted by the network node 110, corresponds to a set of beams of the RIS. For example, the network node 110 may transmit a first beam to the UE 120 on a direct link, a second beam to the UE 120 on a direct link, and a third beam to the RIS for forwarding to UE 120 on an indirect link. In a beam management procedure, the RIS may have a set of beams on which the RIS can forward communications to the UE 120, and the RIS may perform beam sweeping across the set of beams. For example, when the network node 110 transmits the third beam to the RIS, the RIS may transmit a first redirected beam, a second redirected beam, and a third redirected beam toward the UE 120. To cause the RIS to transmit multiple redirected beams, the network node 110 may transmit a plurality of beams to the RIS with control information to cause the RIS to redirect the plurality of beams using different redirected beams.

The UE 120 may perform measurements of beams (including the redirected beams), as described in more detail herein, and provide information regarding the measurements to the network node 110. For example, the UE 120 may report a strongest redirected beam, to enable the network node 110 to configure the RIS to use the strongest redirected beam for an indirect link between the network node 110 and the UE 120. The network node 110 may select a beam on a direct link or may select a beam on the indirect link (e.g., a beam toward the RIS and a redirection beam from the RIS) for communication with the UE 120. This process may be transparent to the UE 120. In other words, the UE 120 may treat the redirected beams as if they were direct link beams from the network node 110, thereby obviating a need for new initial access procedures to be provided to the UE 120 to enable compatibility with RIS-based communications. In this way, legacy initial access procedures can be used to accommodate RIS beam-sweeping and RIS-based communications.

As shown in FIG. 6, example 610 may include a network node 110 and a UE 120 communicating to perform beam management using CSI-RSs. Example 610 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 6 and example 610, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 6, example 620 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 6 and example 620, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 6 is provided as an example of beam management procedures. Other examples of beam management procedures may differ from what is described with respect to FIG. 6. For example, the UE 120 and the network node 110 may perform the third beam management procedure before performing the second beam management procedure, and/or the UE 120 and the network node 110 may perform a similar beam management procedure to select a UE transmit beam.

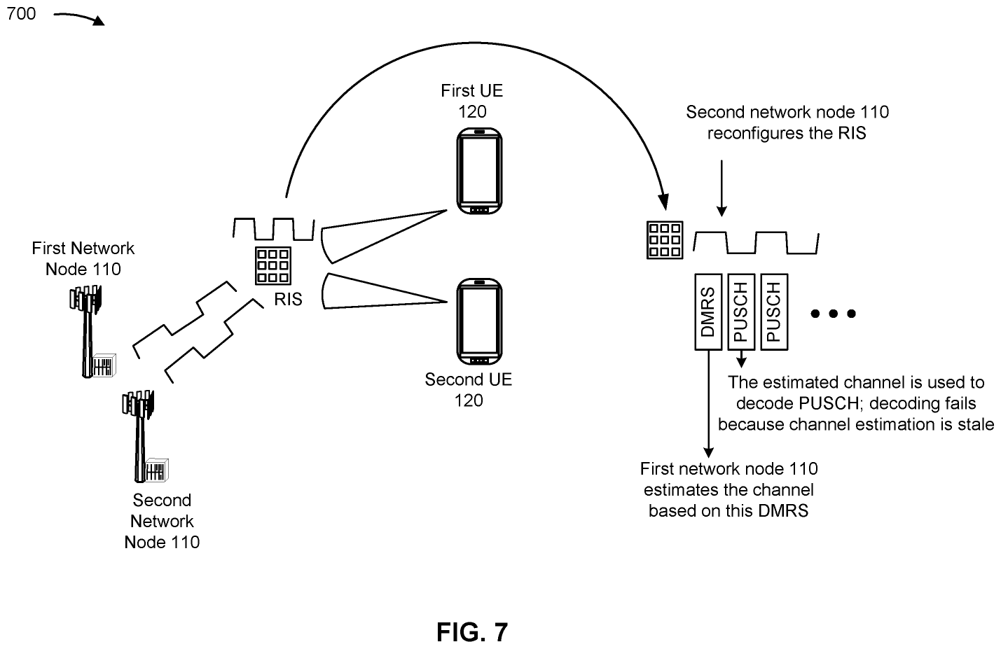

FIG. 7 is a diagram illustrating an example 700 of RIS configuration in a multi-operator scenario, in accordance with the present disclosure.

As shown in FIG. 7, an RIS can be deployed in a communication scenario in which multiple operators are providing communication services in the same area. For example, a first network node 110, associated with a first operator, may communicate with a first UE 120 and a second network node 110, associated with a second operator, may communicate with a second UE 120. In this case, the RIS may be associated with the second network node 110 and the second operator. For example, the second network node 110 may control a configuration of the RIS and the first network node 110 may lack information regarding the configuration of the RIS.

Accordingly, when the first network node 110 performs channel estimation with the first UE 120, the configuration of the RIS may result in the channel estimation failing to accurately reflect channel conditions at a subsequent time. For example, the second network node 110 may configure the RIS such that a demodulation reference signal (DMRS) is sent in a symbol 0 and data is sent in a symbol 1 at a first time. The first network node 110 may perform channel estimation and may identify the transmission of the DMRS in symbol 0 and data in symbol 1. However, at a second time, the second network node 110 may reconfigure the RIS, such that data is sent in symbol 0 and a DMRS is sent in symbol 0. Because the first network node 110 is not alerted to this configuration change, the channel estimation performed by the first network node 110 at the first time is stale for the second time (e.g., the channel estimation, from the first time, is no longer reflective of channel conditions at the second time). In this case, channel estimation that was based at least in part on a DMRS in symbol 0 at the first time cannot be used for decoding of a physical uplink shared channel (PUSCH) by the first UE 120 at the second time, resulting in failed communications.

As indicated above, FIG. 7 is provided as an example. Other examples may differ from what is described with respect to FIG. 7.

Some aspects described herein enable coordination between network devices. For example, a first network node may receive, from a second network node associated with an RIS, coordination information. The coordination information may include positioning information identifying a location of the RIS. In this case, the first network node can restrict one or more beams on UEs associated with the first network node to mitigate an effect of RIS interference. Additionally, or alternatively, the coordination information may include beam information identifying a set of beams to restrict to avoid an effect of RIS interference. In some examples, the coordination information may be conveyed on an X2 or Xn interface (e.g., when the network nodes are base stations) or on a sidelink interface (e.g., a direct or indirect sidelink interface, when the network nodes are UEs in a sidelink deployment). In this way, the first network node can adjust a communication configuration with, for example, a UE, thereby reducing a likelihood of dropped communications and/or interference associated with an RIS.

FIGS. 8A and 8B are diagrams illustrating an example 800 associated with coordination between network devices, in accordance with the present disclosure. As shown in FIG. 8A, example 800 includes communication between a first network node 110, a second network node 110, and an RIS 805 (which may correspond to the RIS 405 described herein with regard to FIGS. 4 and 5).

As further shown in FIG. 8A, and by reference number 810, the first network node 110 may receive coordination information from the second network node 110. For example, the first network node 110 may receive information identifying a position of the RIS 805. In this case, the first network node 110 may use the information identifying the position of the RIS 805 to identify one or more beams for which the RIS 805 may cause interference and restrict usage of the one or more beams during communication with the UE 120. A beam may include an analog beam, a digital beam, a combination thereof, or another type of beam. In this way, the first network node 110 may mitigate an effect of RIS interference and/or a negative impact to communication performance from RIS interference. Additionally, or alternatively, the first network node 110 may receive information identifying a set of beams that are to be restricted to avoid RIS interference. For example, the second network node 110 may identify the set of beams that can be affected by RIS interference (e.g., based at least in part on a position of the RIS 805) and may indicate the set of beams to the first network node 110 to enable the first network node 110 to restrict usage of the set of beams. In this case, the first network node 110 may forward information identifying the set of beams to the UE 120 to enable the UE 120 to avoid using any of the set of beams (and to cause the UE 120 to use other beams), thereby reducing a likelihood of RIS interference. In some aspects, the first network node 110 may receive information identifying a power state of the RIS 805 (e.g., whether the RIS 805 is in an off state or an on state and/or a pattern for switching power states), a communication configuration for the RIS 805, or a change to a communication configuration of the RIS 805 (e.g., a change to an RIS beamformer), among other examples.

In some aspects, the first network node 110 may receive the coordination information via an X2 or Xn interface. For example, as shown in FIG. 8B, and by diagram 850, when the network nodes 110 are base stations or gNBs, the network nodes 110 may communicate via an X2 or Xn interface to provide coordination information. In another example, as shown in FIG. 8B, and by diagram 860, in an IoT deployment, a first programmable logic controller (PLC) (PLC1) type of network node 110 may reserve the RIS 805 for a duration of time. The first PLC may have a first UE (s1) and a second UE (s2). A second PLC (PLC2) may have a third UE (s3) and a fourth UE (s4). The s1 can communicate with the s3 directly (e.g., via a sidelink connection) or can communicate with the second PLC directly. Although some aspects are described herein in terms of network nodes and UEs, it is contemplated that UEs may configure exchange coordination information associated with RISs and configure beams in, for example, a sidelink deployment. In this example, if a radio resource control (RRC) message is used for configuration of a connection (e.g., between the second PLC and the s1) the coordination information can be conveyed via the RRC message. After RRC connection, the coordination indication can be conveyed via a Layer 1 message (e.g., sidelink control information (SCI) or a physical sidelink shared channel), a Layer 2 message (e.g., a medium access control (MAC) control element (CE)), or a Layer 3 message (e.g., another RRC message), among other examples.

As further shown in FIG. 8A, and by reference numbers 815 and 820, the first network node 110 may configure beams for communication with the UE 120 and may communicate with the UE 120 using the configured beams. For example, the first network node 110 may restrict one or more beams that the UE 120 and the first network node 110 may use for communication. Restricting one or more beams may include not using the one or more beams, adjusting a transmission strength for transmissions using the one or more beams, adjusting a modulation and coding scheme (MCS) for transmissions using the one or more beams, or altering quasi-co-location (QCL) parameters for the one or more beams, among other examples. For example, the first network node 110 may select a lower MCS for slots where the RIS 805 is in an on state (where interference can occur from the RIS 805) than for slots where the RIS 805 is in an off state (where interference is not occurring from the RIS 805). In this case, the first network node 110 may indicate a delta value (e.g., an amount of change to an MCS), a table entry (e.g., corresponding to an MCS selection), or an MCS indicator to identify the MCS that the UE 120 is to use for communications. Additionally, or alternatively, the first network node 110 may indicate a change to the MCS corresponding to a change to the RIS 805. For example, the first network node 110 may indicate an MCS to use when an RIS beamformer is changed (e.g., a pairing between beams, MCSs, and RIS beamformer states, among other examples). The communications, for which the one or more beams may be restricted, may include uplink communications by the UE 120, downlink communications to the UE 120, or sidelink communications including the UE 120. Additionally, or alternatively, the communications may include other communications not including the UE 120. For example, the first network node 110 may transmit information identifying a restriction for one or more beams to the UE 120, which the UE 120 may forward to another UE 120 for use when the other UE 120 communicates.

In some aspects, the first network node 110 may be configured to communicate with the RIS 805. For example, the first network node 110 may transmit reference signals toward the RIS 805, which is associated with the second network node 110, to self-determine a beam impact, an interference level, or a power state of the RIS. In this case, the first network node 110 may communicate with the second network node 110 (e.g., via an X2 or Xn interface) to configure reference signal transmission or to report results of the reference signal transmission to, for example, cause the second network node 110 to reconfigure the RIS 805 based at least in part on a result of reference signal transmission.

As further shown in FIG. 8A, and by reference number 825, the second network node 110 may configure the RIS 805. For example, the second network node 110 may configure the RIS 805 based at least in part on providing coordination information to the first network node 110. Additionally, or alternatively, the second network node 110 may configure the RIS 805 and may provide coordination information to the first network node 110 identifying the configuration of the RIS 805. For example, the second network node 110 may indicate the configuration of the RIS 805 along with the position information of the RIS 805 provided in the coordination information.

In some aspects, the second network node 110 may set a time-domain restriction on an RIS beamformer configuration of the RIS 805. For example, the second network node 110 may limit an amount of variation (e.g., a speed with which a configuration varies or an amount by which a configuration varies) of a configuration of the RIS 805 to avoid a channel estimation becoming stale, as described above. In this case, the second network node 110 may restrict the RIS beamformer variation across a set of slots, within a set of slots, within a set of symbols, within a single symbol, within a subslot, or within another type of time interval. Additionally, or alternatively, the second network node 110 may configure the RIS 805 to be in an on state or an off state (e.g., as a static configuration or as a pattern of switching between states). In this case, the second network node 110 may indicate, to the first network node 110, whether the RIS 805 is in an on state or an off state (or the pattern of switching between states). The first network node 110 may restrict beams when the RIS 805 is in an on state, but may forgo restricting beams (e.g., not restrict beams) when the RIS 805 is in an off state.

As indicate above, FIGS. 8A and 8B are provided as examples. Other examples may differ from what is described with respect to FIGS. 8A and 8B.

FIG. 9 is a diagram illustrating an example process 900 performed, for example, by a first network node, in accordance with the present disclosure. Example process 900 is an example where the first network node (e.g., first network node 110) performs operations associated with coordination between network devices.

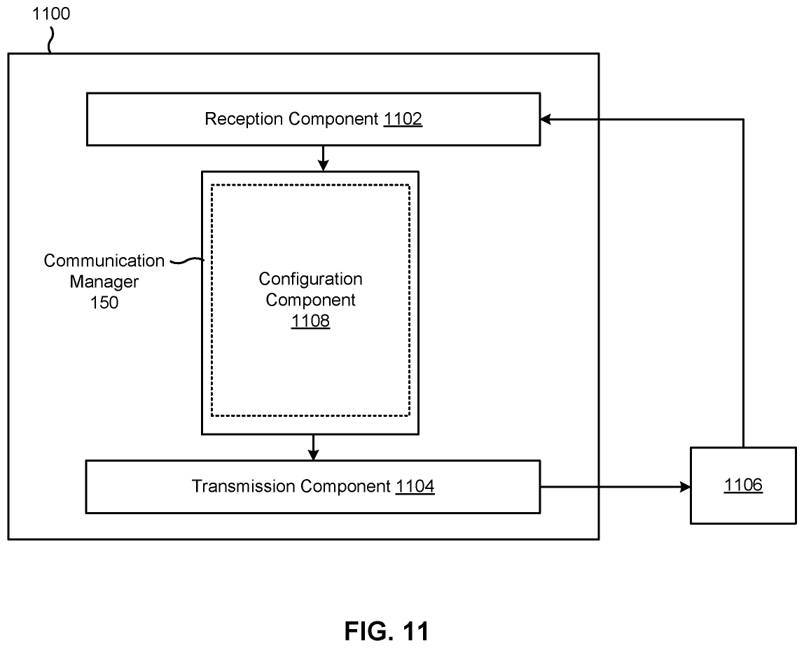

As shown in FIG. 9, in some aspects, process 900 may include receiving, from a second network node associated with an RIS, positioning information associated with the RIS (block 910). For example, the first network node (e.g., using communication manager 150 and/or reception component 1102, depicted in FIG. 11) may receive, from a second network node associated with an RIS, positioning information associated with the RIS, as described above.

As further shown in FIG. 9, in some aspects, process 900 may include communicating, with a third network node, using a beam of a set of beams that is configured based at least in part on the positioning information (block 920). For example, the first network node (e.g., using communication manager 150 and/or reception component 1102 or transmission component 1104, depicted in FIG. 11) may communicate, with a third network node, using a beam of a set of beams that is configured based at least in part on the positioning information, as described above.

Process 900 may include additional aspects, such as any single aspect or any combination of aspects described below and/or in connection with one or more other processes described elsewhere herein.

In a first aspect, the set of beams is configured, based at least in part on the positioning information, with at least one beam restricted in connection with the RIS.

In a second aspect, alone or in combination with the first aspect, process 900 includes receiving information identifying one or more beams for which the RIS is associated with causing interference, and configuring the set of beams based at least in part on the information identifying the one or more beams.

In a third aspect, alone or in combination with one or more of the first and second aspects, process 900 includes receiving information identifying a mode of operation, and configuring the set of beams based at least in part on the mode of operation.

In a fourth aspect, alone or in combination with one or more of the first through third aspects, receiving the positioning information comprises receiving the positioning information via at least one of an X2 interface, an Xn interface, a radio resource control connection, a layer 1 message, a shared channel message, a sidelink control message, or a medium access control (MAC) control element.

In a fifth aspect, alone or in combination with one or more of the first through fourth aspects, process 900 includes receiving information identifying a configuration of a time domain restriction for the RIS, and configuring the set of beams based at least in part on the configuration of the time domain restriction.

In a sixth aspect, alone or in combination with one or more of the first through fifth aspects, process 900 includes receiving information identifying a configuration of a usage pattern for the RIS, and configuring the set of beams based at least in part on the configuration of the usage pattern.

In a seventh aspect, alone or in combination with one or more of the first through sixth aspects, process 900 includes receiving information identifying a configuration of a modulation and coding scheme for the RIS, and configuring the set of beams based at least in part on the configuration of the modulation and coding scheme.

In an eighth aspect, alone or in combination with one or more of the first through seventh aspects, process 900 includes transmitting one or more reference signals, receiving, based at least in part on transmitting the one or more reference signals, information identifying an impact of the RIS on interference for the set of beams, and configuring the set of beams based at least in part on the impact of the RIS on interference for the set of beams.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a second network node, in accordance with the present disclosure. Example process 1000 is an example where the second network node (e.g., second network node 110) performs operations associated with coordination between network devices.

As shown in FIG. 10, in some aspects, process 1000 may include configuring an RIS associated with the second network node (block 1010). For example, the second network node (e.g., using communication manager 150 and/or configuration component 1108, depicted in FIG. 11) may configure an RIS associated with the second network node, as described above.

As further shown in FIG. 10, in some aspects, process 1000 may include transmitting, to a first network node and based at least in part on configuring the RIS, positioning information associated with the RIS to enable the first network node to communicate with a third network node using a beam of a set of beams that is configured based at least in part on the positioning information (block 1020). For example, the second network node (e.g., using communication manager 150 and/or transmission component 1104, depicted in FIG. 11) may transmit, to a first network node and based at least in part on configuring the RIS, positioning information associated with the RIS to enable the first network node to communicate with a third network node using a beam of a set of beams that is configured based at least in part on the positioning information, as described above.

Process 1000 may include additional aspects, such as any single aspect or any combination of aspects described below and/or in connection with one or more other processes described elsewhere herein.

In a first aspect, process 1000 includes configuring the set of beams based at least in part on the positioning information, with at least one beam restricted in connection with the RIS.

In a second aspect, alone or in combination with the first aspect, process 1000 includes transmitting information identifying one or more beams for which the RIS is associated with causing interference, and configuring the set of beams based at least in part on the information identifying the one or more beams.

In a third aspect, alone or in combination with one or more of the first and second aspects, process 1000 includes transmitting information identifying a mode of operation, and configuring the set of beams based at least in part on the mode of operation.

In a fourth aspect, alone or in combination with one or more of the first through third aspects, transmitting the positioning information comprises transmitting the positioning information via at least one of an X2 interface, an Xn interface, a radio resource control connection, a layer 1 message, a shared channel message, a sidelink control message, or a MAC control element.

In a fifth aspect, alone or in combination with one or more of the first through fourth aspects, process 1000 includes transmitting information identifying a configuration of a time domain restriction for the RIS, and configuring the set of beams based at least in part on the configuration of the time domain restriction.

In a sixth aspect, alone or in combination with one or more of the first through fifth aspects, process 1000 includes transmitting information identifying a configuration of a usage pattern for the RIS, and configuring the set of beams based at least in part on the configuration of the usage pattern.

In a seventh aspect, alone or in combination with one or more of the first through sixth aspects, configuring the RIS comprises configuring a modulation and coding scheme for the RIS, and configuring the set of beams based at least in part on the configuring of the modulation and coding scheme.

In an eighth aspect, alone or in combination with one or more of the first through seventh aspects, process 1000 includes receiving one or more reference signals, transmitting, based at least in part on receiving the one or more reference signals, information identifying an impact of the RIS on interference for the set of beams, and configuring the set of beams based at least in part on the impact of the RIS on interference for the set of beams.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a configuration component 1108, among other examples.

In some aspects, the apparatus 1100 may be configured to perform one or more operations described herein in connection with FIGS. 8A-8B. Additionally, or alternatively, the apparatus 1100 may be configured to perform one or more processes described herein, such as process 900 of FIG. 9, process 1000 of FIG. 10, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The reception component 1102 may receive, from the apparatus 1106 associated with an RIS, positioning information associated with the RIS. The reception component 1102 and/or the transmission component 1104 may communicate, with another apparatus 1106, using a beam of a set of beams that is configured based at least in part on the positioning information. The reception component 1102 may receive information identifying one or more beams for which the RIS is associated with causing interference.

The configuration component 1108 may configure the set of beams based at least in part on the information identifying the one or more beams. The reception component 1102 may receive information identifying a mode of operation. The configuration component 1108 may configure the set of beams based at least in part on the mode of operation. The reception component 1102 may receive information identifying a configuration of a time domain restriction for the RIS. The configuration component 1108 may configure the set of beams based at least in part on the configuration of the time domain restriction. The reception component 1102 may receive information identifying a configuration of a usage pattern for the RIS.

The configuration component 1108 may configure the set of beams based at least in part on the configuration of the usage pattern. The reception component 1102 may receive information identifying a configuration of a modulation and coding scheme for the RIS. The configuration component 1108 may configure the set of beams based at least in part on the configuration of the modulation and coding scheme. The transmission component 1104 may transmit one or more reference signals. The reception component 1102 may receive, based at least in part on transmitting the one or more reference signals, information identifying an impact of the RIS on interference for the set of beams. The configuration component 1108 may configure the set of beams based at least in part on the impact of the RIS on interference for the set of beams.

The configuration component 1108 may configure an RIS associated with the apparatus 1106. The transmission component 1104 may transmit, to the apparatus 1106 and based at least in part on configuring the RIS, positioning information associated with the RIS to enable the apparatus 1106 to communicate with another apparatus 1106 using a beam of a set of beams that is configured based at least in part on the positioning information. The configuration component 1108 may configure the set of beams based at least in part on the positioning information, with at least one beam restricted in connection with the RIS. The transmission component 1104 may transmit information identifying one or more beams for which the RIS is associated with causing interference.

The configuration component 1108 may configure the set of beams based at least in part on the information identifying the one or more beams. The transmission component 1104 may transmit information identifying a mode of operation. The configuration component 1108 may configure the set of beams based at least in part on the mode of operation. The transmission component 1104 may transmit information identifying a configuration of a time domain restriction for the RIS. The configuration component 1108 may configure the set of beams based at least in part on the configuration of the time domain restriction.

The transmission component 1104 may transmit information identifying a configuration of a usage pattern for the RIS. The configuration component 1108 may configure the set of beams based at least in part on the configuration of the usage pattern. The reception component 1102 may receive one or more reference signals. The transmission component 1104 may transmit, based at least in part on receiving the one or more reference signals, information identifying an impact of the RIS on interference for the set of beams. The configuration component 1108 may configure the set of beams based at least in part on the impact of the RIS on interference for the set of beams.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a first network node, comprising: receiving, from a second network node associated with a reconfigurable intelligent surface (RIS), positioning information associated with the RIS; and communicating, with a third network node, using a beam of a set of beams that is configured based at least in part on the positioning information.

Aspect 2: The method of Aspect 1, wherein the set of beams is configured, based at least in part on the positioning information, with at least one beam restricted in connection with the RIS.

Aspect 3: The method of any of Aspects 1 to 2, further comprising: receiving information identifying one or more beams for which the RIS is associated with causing interference; and configuring the set of beams based at least in part on the information identifying the one or more beams.

Aspect 4: The method of any of Aspects 1 to 3, further comprising: receiving information identifying a mode of operation; and configuring the set of beams based at least in part on the mode of operation.

Aspect 5: The method of any of Aspects 1 to 4, wherein receiving the positioning information comprises receiving the positioning information via at least one of: an X2 interface, an Xn interface, a radio resource control connection, a layer 1 message, a shared channel message, a sidelink control message, or a medium access control (MAC) control element.

Aspect 6: The method of any of Aspects 1 to 5, further comprising: receiving information identifying a configuration of a time domain restriction for the RIS; and configuring the set of beams based at least in part on the configuration of the time domain restriction.

Aspect 7: The method of any of Aspects 1 to 6, further comprising: receiving information identifying a configuration of a usage pattern for the RIS; and configuring the set of beams based at least in part on the configuration of the usage pattern.

Aspect 8: The method of any of Aspects 1 to 7, further comprising: receiving information identifying a configuration of a modulation and coding scheme for the RIS; and configuring the set of beams based at least in part on the configuration of the modulation and coding scheme.

Aspect 9: The method of any of Aspects 1 to 8, further comprising: transmitting one or more reference signals; receiving, based at least in part on transmitting the one or more reference signals, information identifying an impact of the RIS on interference for the set of beams; and configuring the set of beams based at least in part on the impact of the RIS on interference for the set of beams.

Aspect 10: A method of wireless communication performed by a second network node, comprising: configuring a reconfigurable intelligent surface (RIS) associated with the second network node; and transmitting, to a first network node and based at least in part on configuring the RIS, positioning information associated with the RIS to enable the first network node to communicate with a third network node using a beam of a set of beams that is configured based at least in part on the positioning information.

Aspect 11: The method of Aspect 10, further comprising: configuring the set of beams based at least in part on the positioning information, with at least one beam restricted in connection with the RIS.

Aspect 12: The method of any of Aspects 10 to 11, further comprising: transmitting information identifying one or more beams for which the RIS is associated with causing interference; and configuring the set of beams based at least in part on the information identifying the one or more beams.

Aspect 13: The method of any of Aspects 10 to 12, further comprising: transmitting information identifying a mode of operation; and configuring the set of beams based at least in part on the mode of operation.

Aspect 14: The method of any of Aspects 10 to 13, wherein transmitting the positioning information comprises transmitting the positioning information via at least one of: an X2 interface, an Xn interface, a radio resource control connection, a layer 1 message, a shared channel message, a sidelink control message, or a medium access control (MAC) control element.

Aspect 15: The method of any of Aspects 10 to 14, further comprising: transmitting information identifying a configuration of a time domain restriction for the RIS; and configuring the set of beams based at least in part on the configuration of the time domain restriction.

Aspect 16: The method of any of Aspects 10 to 15, further comprising: transmitting information identifying a configuration of a usage pattern for the RIS; and configuring the set of beams based at least in part on the configuration of the usage pattern.

Aspect 17: The method of any of Aspects 10 to 16, wherein configuring the RIS comprises: configuring a modulation and coding scheme for the RIS; and configuring the set of beams based at least in part on the configuring of the modulation and coding scheme.

Aspect 18: The method of any of Aspects 10 to 17, further comprising: receiving one or more reference signals; transmitting, based at least in part on receiving the one or more reference signals, information identifying an impact of the RIS on interference for the set of beams; and configuring the set of beams based at least in part on the impact of the RIS on interference for the set of beams.

Aspect 19: An apparatus for wireless communication at a device, comprising a processor; memory coupled with the processor; and instructions stored in the memory and executable by the processor to cause the apparatus to perform the method of one or more of Aspects 1-9.

Aspect 20: A device for wireless communication, comprising a memory and one or more processors coupled to the memory, the one or more processors configured to perform the method of one or more of Aspects 1-9.

Aspect 21: An apparatus for wireless communication, comprising at least one means for performing the method of one or more of Aspects 1-9.

Aspect 22: A non-transitory computer-readable medium storing code for wireless communication, the code comprising instructions executable by a processor to perform the method of one or more of Aspects 1-9.

Aspect 23: A non-transitory computer-readable medium storing a set of instructions for wireless communication, the set of instructions comprising one or more instructions that, when executed by one or more processors of a device, cause the device to perform the method of one or more of Aspects 1-9.

Aspect 24: An apparatus for wireless communication at a device, comprising a processor; memory coupled with the processor; and instructions stored in the memory and executable by the processor to cause the apparatus to perform the method of one or more of Aspects 10-18.

Aspect 25: A device for wireless communication, comprising a memory and one or more processors coupled to the memory, the one or more processors configured to perform the method of one or more of Aspects 10-18.

Aspect 26: An apparatus for wireless communication, comprising at least one means for performing the method of one or more of Aspects 10-18.

Aspect 27: A non-transitory computer-readable medium storing code for wireless communication, the code comprising instructions executable by a processor to perform the method of one or more of Aspects 10-18.

Aspect 28: A non-transitory computer-readable medium storing a set of instructions for wireless communication, the set of instructions comprising one or more instructions that, when executed by one or more processors of a device, cause the device to perform the method of one or more of Aspects 10-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first network node for wireless communication, comprising:
a memory; and
one or more processors, coupled to the memory, configured to:
receive, from a second network node associated with a reconfigurable intelligent surface (RIS), positioning information associated with the RIS; and
communicate, with a third network node, using a beam of a set of beams that is configured based at least in part on the positioning information.

2. The first network node of claim 1, wherein the set of beams is configured, based at least in part on the positioning information, with at least one beam restricted in connection with the RIS.

3. The first network node of claim 1, wherein the one or more processors are further configured to:
receive information identifying one or more beams for which the RIS is associated with causing interference; and
configure the set of beams based at least in part on the information identifying the one or more beams.

4. The first network node of claim 1, wherein the one or more processors are further configured to:
receive information identifying a mode of operation; and
configure the set of beams based at least in part on the mode of operation.

5. The first network node of claim 1, wherein the one or more processors, to receive the positioning information, are configured to receive the positioning information via at least one of:
an X2 interface,
an Xn interface,
a radio resource control connection,
a layer 1 message,
a shared channel message,
a sidelink control message, or
a medium access control (MAC) control element.

6. The first network node of claim 1, wherein the one or more processors are further configured to:
receive information identifying a configuration of a time domain restriction for the RIS; and
configure the set of beams based at least in part on the configuration of the time domain restriction.

7. The first network node of claim 1, wherein the one or more processors are further configured to:
receive information identifying a configuration of a usage pattern for the RIS; and
configure the set of beams based at least in part on the configuration of the usage pattern.

8. The first network node of claim 1, wherein the one or more processors are further configured to:
receive information identifying a configuration of a modulation and coding scheme for the RIS; and
configure the set of beams based at least in part on the configuration of the modulation and coding scheme.

9. The first network node of claim 1, wherein the one or more processors are further configured to:
transmit one or more reference signals;
receive, based at least in part on transmitting the one or more reference signals, information identifying an impact of the RIS on interference for the set of beams; and
configure the set of beams based at least in part on the impact of the RIS on interference for the set of beams.

10. A second network node for wireless communication, comprising:
a memory; and
one or more processors, coupled to the memory, configured to:
configure a reconfigurable intelligent surface (RIS) associated with the second network node; and
transmit, to a first network node and based at least in part on configuring the RIS, positioning information associated with the RIS to enable the first network node to communicate with a third network node using a beam of a set of beams that is configured based at least in part on the positioning information.

11. The second network node of claim 10, wherein the one or more processors are further configured to:
configure the set of beams based at least in part on the positioning information, with at least one beam restricted in connection with the RIS.

12. The second network node of claim 10, wherein the one or more processors are further configured to:
transmit information identifying one or more beams for which the RIS is associated with causing interference; and
configure the set of beams based at least in part on the information identifying the one or more beams.

13. The second network node of claim 10, wherein the one or more processors are further configured to:
transmit information identifying a mode of operation; and
configure the set of beams based at least in part on the mode of operation.

14. The second network node of claim 10, wherein the one or more processors, to transmit the positioning information, are configured to transmit the positioning information via at least one of:
an X2 interface,
an Xn interface,
a radio resource control connection,
a layer 1 message,
a shared channel message,
a sidelink control message, or
a medium access control (MAC) control element.

15. The second network node of claim 10, wherein the one or more processors are further configured to:
transmit information identifying a configuration of a time domain restriction for the RIS; and
configure the set of beams based at least in part on the configuration of the time domain restriction.

16. The second network node of claim 10, wherein the one or more processors are further configured to:
transmit information identifying a configuration of a usage pattern for the RIS; and
configure the set of beams based at least in part on the configuration of the usage pattern.

17. The second network node of claim 10, wherein the one or more processors, to configure the RIS, are configured to:
configure a modulation and coding scheme for the RIS; and
configure the set of beams based at least in part on the configuring of the modulation and coding scheme.

18. The second network node of claim 10, wherein the one or more processors are further configured to:
receive one or more reference signals;
transmit, based at least in part on receiving the one or more reference signals, information identifying an impact of the RIS on interference for the set of beams; and
configure the set of beams based at least in part on the impact of the RIS on interference for the set of beams.

19. A method of wireless communication performed by a first network node, comprising:
receiving, from a second network node associated with a reconfigurable intelligent surface (RIS), positioning information associated with the RIS; and
communicating, with a third network node, using a beam of a set of beams that is configured based at least in part on the positioning information.

20. The method of claim 19, wherein the set of beams is configured, based at least in part on the positioning information, with at least one beam restricted in connection with the RIS.

21. The method of claim 19, further comprising:
receiving information identifying one or more beams for which the RIS is associated with causing interference; and
configuring the set of beams based at least in part on the information identifying the one or more beams.

22. The method of claim 19, further comprising:
receiving information identifying a mode of operation; and
configuring the set of beams based at least in part on the mode of operation.

23. The method of claim 19, wherein receiving the positioning information comprises receiving the positioning information via at least one of:
an X2 interface,
an Xn interface,
a radio resource control connection,
a layer 1 message,
a shared channel message,
a sidelink control message, or
a medium access control (MAC) control element.

24. The method of claim 19, further comprising:
receiving information identifying a configuration of a time domain restriction for the RIS; and
configuring the set of beams based at least in part on the configuration of the time domain restriction.

25. The method of claim 19, further comprising:
receiving information identifying a configuration of a usage pattern for the RIS; and
configuring the set of beams based at least in part on the configuration of the usage pattern.

26. The method of claim 19, further comprising:
receiving information identifying a configuration of a modulation and coding scheme for the RIS; and
configuring the set of beams based at least in part on the configuration of the modulation and coding scheme.

27. The method of claim 19, further comprising:
transmitting one or more reference signals;
receiving, based at least in part on transmitting the one or more reference signals, information identifying an impact of the RIS on interference for the set of beams; and
configuring the set of beams based at least in part on the impact of the RIS on interference for the set of beams.

28. A method of wireless communication performed by a second network node, comprising:
configuring a reconfigurable intelligent surface (RIS) associated with the second network node; and
transmitting, to a first network node and based at least in part on configuring the RIS, positioning information associated with the RIS to enable the first network node to communicate with a third network node using a beam of a set of beams that is configured based at least in part on the positioning information.

29. The method of claim 28, further comprising:
configuring the set of beams based at least in part on the positioning information, with at least one beam restricted in connection with the RIS.

30. The method of claim 28, further comprising:
transmitting information identifying one or more beams for which the RIS is associated with causing interference; and
configuring the set of beams based at least in part on the information identifying the one or more beams.
